(19) United States
(12) Patent Application Publication
(10) Pub. No.: US 2025/0307194 A1
(43) Pub. Date: Oct. 2, 2025

(54) SYSTEMS AND METHODS FOR DATA TRANSFER CONTROL CIRCUITRY

(71) Applicant: ATI Technologies ULC, Markham (CA)

(72) Inventors: YanFeng Wang, Markham (CA); Shaofeng An, Markham (CA)

(73) Assignee: ATI Technologies ULC, Markham (CA)

(21) Appl. No.: 18/622,680

(22) Filed: Mar. 29, 2024

(51) Int. Cl. G06F 13/40

(52) U.S. Cl. CPC G06F 13/4022; G06F 2213/0016

(57) ABSTRACT

The disclosed device includes a first node, a second node, a link, and flow-control circuitry configured to transmit data through the link, from the first node to the second node, at a designated frequency corresponding to the lowest of three maximum frequencies (e.g., a first maximum frequency at which the first node is predicted to be able to release data, a second maximum frequency at which data is predicted to be able to pass through the link from the first node to the second node, and a third maximum frequency at which the second node is predicted to be able to receive data). Various other methods, systems, and computer-readable media are also disclosed.

### BACKGROUND

Data must be transmitted between various nodes of a device (e.g., from one die to another within an integrated circuit and/or from one socket to another within a printed circuit board). To avoid data overflow at a receiving node, the rate (e.g., frequency) of data transmission is tightly controlled. However, traditional approaches are inefficient.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for data transfer rate control.

FIG. 2 is a flow diagram of an exemplary instruction pipeline.

FIG. 3 is a block diagram of an exemplary multi-die integrated circuit with two nodes (e.g., a first die and a second die).

FIG. 4 is a block diagram of an exemplary printed circuit board with two nodes (e.g., a first socket and a second socket).

FIG. 5 is a flow diagrams of an exemplary method for data transfer rate control.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

In some traditional circuit architectures (e.g., traditional Chiplet architecture), data transfer between two nodes (e.g., from the Transmit-Data-First-in-First-Out (TxFIFO) data storage of a first node to the Receive-Data-First-in-First-Out (RxFIFO) data storage of a second node) is based on a credit control framework, in which credit is released (allowing more data to be sent from the first node) when data is read out from the second node (e.g., from the RxFIFO data storage of the second node). A credit control framework is inefficient, increasing latency and leaving data to accumulate at the first node as the first node waits for credit to be released by the second node.

As an alternative to credit control data transfer, the disclosed data transfer framework sets a rate (e.g., speed) of data transfer based on the lowest of three maximum rates (e.g., three bandwidths). These include a first maximum rate (e.g., the maximum rate at which the first node is predicted to be able to release data), a second maximum rate (e.g., the maximum rate at which data is predicted to be able to pass through a link to the second node) and a third maximum rate (e.g., the maximum rate at which the second node is predicted to be able to receive data). This improved framework ensures that all FIFOs run at a synchronous (e.g., pacing) mode, reducing latency by allowing continuous data transmission instead of the stop-and-go data transmission of traditional approaches. This framework also enables the use of storage at the first and/or second nodes that are much smaller than the storage required under traditional approaches.

In one implementation, a device with controlled data flow (e.g., between different nodes of the device) includes a first node (e.g., a first die within an integrated circuit and/or a first socket corresponding to a first die on a printed circuit board), a second node (e.g., a second die within the integrated circuit and/or a second socket corresponding to a second die on the printed circuit board), a link, and flow-control circuitry (e.g., located on the first node) configured to transmit data through the link, from the first node to the second node, at a designated frequency corresponding to the lowest of three maximum frequencies (e.g., a first maximum frequency at which the first node is predicted to be able to release data, a second maximum frequency at which data is predicted to be able to pass through the link from the first node to the second node, and a third maximum frequency at which the second node is predicted to be able to receive data). In one example, the first, second, and/or third maximum frequencies can be dynamic frequencies and the flow-control circuitry can be configured to determine the designated frequency in real-time.

In some examples, the flow-control circuitry can transmit data from the first node to the second node by transmitting data from temporary storage, such as a Transmit-Data-First-in-First-Out (TxFIFO), of the first node to temporary storage, such as a Receive-Data-First-in-First-Out (RxFIFO), of the second node. In some such examples, the flow-control circuitry can be further configured to reduce the frequency at which subsequent data is transmitted, through the link from the first node to the second node, in response to determining that an amount of data that has accumulated, at the RxFIFO storage of the second node, exceeds a threshold.

In some implementation, the techniques described herein relate to a system including a physical memory, a first node configured to transfer data to a second node via a link, and flow-control circuitry (e.g., located on the first node) configured to regulate a rate of data transfer from the first node to the second node by setting the transfer rate to a rate that corresponds to the lowest of three rates (e.g., a first rate at which the first node is predicted to be able to release data, a second rate at which data is predicted to be able to pass through the link from the first node to the second node, and a third rate at which the second node is predicted to be able to receive data).

In some examples, the first node is a first die and the second node is a second die within an integrated circuit. Additionally or alternatively, the first node is a first socket, corresponding to a first die on a printed circuit board, and the second node is a second socket, corresponding to a second die on the printed circuit board. In some implementations, the flow-control circuitry can be configured to calculate the designated rate in real-time.

In some examples, the flow-control circuitry can transfer data from the first node to the second node by transferring data from Transmit Data First in First Out (TxFIFO) storage of the first node to Receive Data First in First Out (Rx FIFO) storage of the second node. In some such examples, the flow-control circuitry can be further configured to reduce the rate at which subsequent data is transmitted, through the link from the first node to the second node, in response to determining that an amount of data that has accumulated, at the RxFIFO storage of the second node, exceeds a threshold.

In some implementations, a computer-implemented method can include transmitting data through a link, from a first node to a second node of a device, at a designated frequency corresponding to the lowest of three maximum frequencies (e.g., a first maximum frequency at which the first node is predicted to be able to release data, a second maximum frequency at which data is predicted to be able to pass through the link from the first node to the second node, and a third maximum frequency at which the second node is predicted to be able to receive data). In one example, the method can further include determining the lowest of the three maximum frequencies and, in response to determining the lowest of the three maximum frequencies, setting the designated frequency at the lowest of the three maximum frequencies. In some examples, the method can also include calculating the designated frequency in real-time.

In some examples, the first node can represent a first die and/or a first socket and the second node can represent a second die and/or a second socket. In one implementation, transmitting data from the first node to the second node can include transmitting data from a TxFIFO of the first node to an RxFIFO of the second node. In on such implementation, the method can further include reducing the frequency at which subsequent data is transmitted, through the link from the first node to the second node, in response to determining that above a threshold amount of data has accumulated at the RxFIFO storage of the second node.

In some examples, the disclosed data transfer framework can include determining a size for a storage (e.g., the RxFIFO storage) of the second node. In some such examples, the size of the storage can be configured to hold ratio, jitter, and/or drift as data is transferred from the first node to the second node. In some examples, a size of the storage can be significantly smaller than a size required for traditional data transfer frameworks (e.g., frameworks with the limitations described previously).

In some examples, the disclosed data transfer framework described herein can operate as part of an Open Systems Interconnection (OSI) model that enables data transfer between two nodes (from a first node to a second node). On the level of a data link layer of the OSI model, the disclosed data transfer framework can involve transferring data from a first Medium Access Control (MAC) sublayer (e.g., a MAC sublayer corresponding to the first node, which can be labeled as MAC A) to a second MAC sublayer (e.g., a MAC sublayer corresponding to the second node, which can be labeled as MAC B). On the level of a physical layer of the OSI model, the disclosed data transfer framework can involve transferring data from a Physical Coding Sublayer (e.g., the PCS corresponding to the first node, which can be labeled as PCS A) to a second Physical Coding Sublayer (e.g., the PCS corresponding to the second node, which can be labeled as PCS B). In these examples, the maximum frequency of data transfer at the first node (e.g., determined by MAC A and PCS A) can differ from the maximum frequency of data transfer at the second node (e.g., determined by MAC B and PCS B).

Features from any of the implementations described herein can be used in combination with one another in accordance with the general principles described herein. These and other implementations, features, and advantages will be more fully understood upon reading the following detailed description in conjunction with the accompanying drawings and claims.

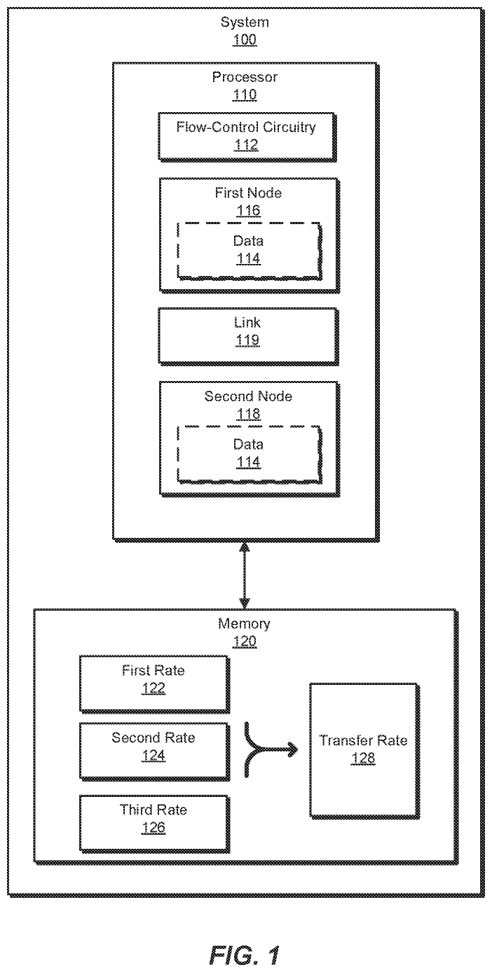

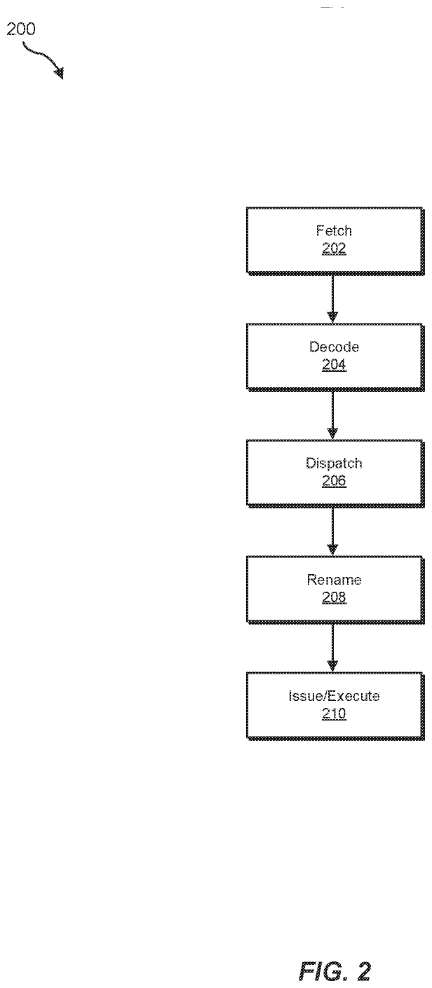

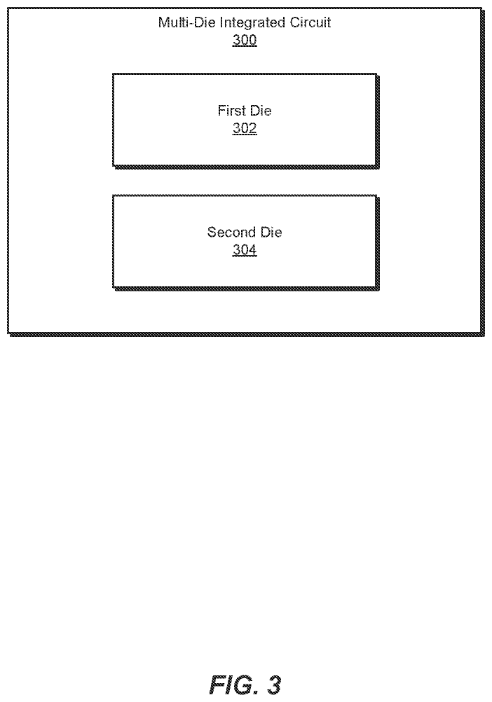

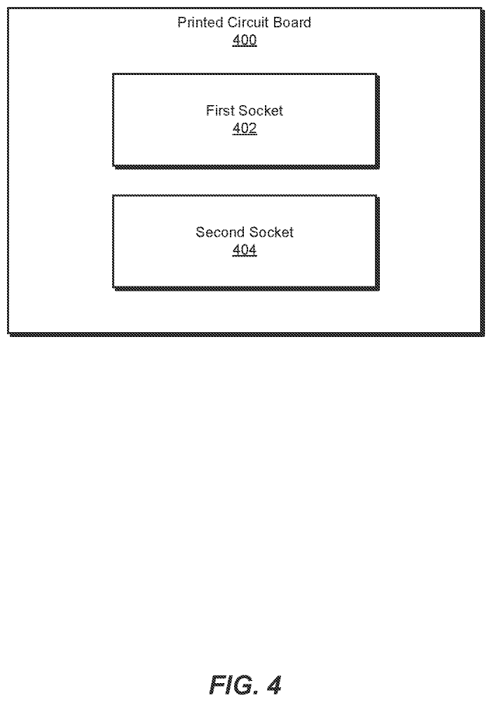

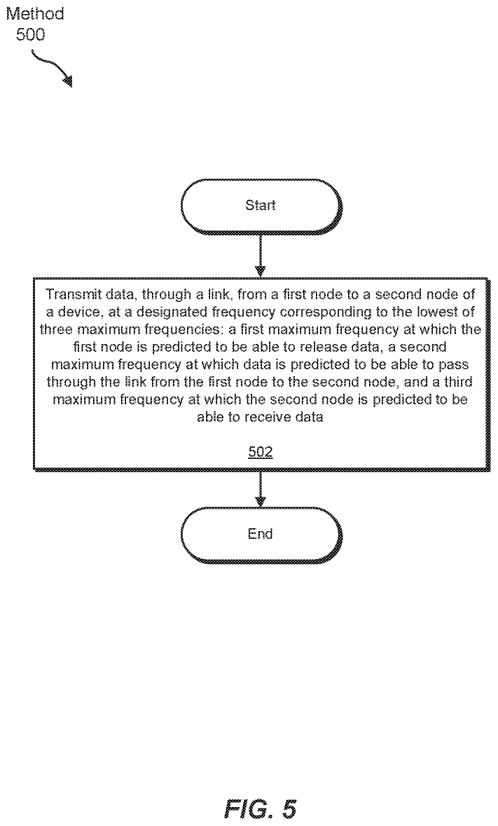

The following will provide, with reference to FIGS. 1-5 detailed descriptions of data transfer rate control. Detailed descriptions of example systems are provided in connection with FIG. 1. Detailed descriptions of an example processor/instruction pipeline are provided in connection with FIG. 2. Detailed descriptions of an example multi-die integrated circuit are provided in connection with FIG. 3. Detailed descriptions of an example printed circuit board are provided in connection with FIG. 4. Detailed descriptions of a corresponding computer-implemented method are provided in connection with FIG. 5.

FIG. 1 is a block diagram of an example system 100 for controlling data flow between nodes of a device. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110. Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, chiplets (e.g., smaller and in some examples more specialized processing units that can coordinate as a single chip), microprocessors, microcontrollers, Central Processing Units (CPUs), graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, graphics processing units (GPUs), portions of one or more of the same, variations or combinations of one or more of the same, and/or any other suitable physical processor. In some examples, processor 110 can represent a multi-die integrated circuit (such as multi-die integrated circuit 300 in FIG. 3) and/or can perform one or more data flow tasks for a multi-die integrated circuit (e.g., multi-die integrated circuit 300 in FIG. 3). In some examples, processor 110 can correspond to a socket within a printed circuit board (e.g., such as printed circuit board 400 in FIG. 4).

In some implementations, the term “instruction” refers to computer code that can be read and executed by a processor. Examples of instructions include, without limitation, macro-instructions (e.g., program code that requires a processor to decode into processor instructions that the processor can directly execute) and micro-operations (e.g., low-level processor instructions that can be decoded from a macro-instruction and that form parts of the macro-instruction).

FIG. 2 illustrates an exemplary pipeline 200 for a processor, such as processor 110 (and/or a functional unit thereof), for executing instructions. During a fetch stage 202, processor 110 can read program instructions from memory 120. Processor 110 can fetch program instructions based on an active thread or other criteria. At decode stage 204, processor 110 can decode the read program instructions into micro-operations. Processor 110 (and/or a functional unit thereof) can forward the newly decoded micro-operations to a scheduler that can queue micro-operations until they are ready for dispatch. At dispatch stage 206, the scheduler can dispatch one or more micro-operations that are ready for dispatch. At rename stage 208, processor 110 can allocate registers to the dispatched micro-operation as needed. At issue/execute stage 210, processor 110 and/or an execution unit thereof executes the dispatched micro-operations.

Although FIG. 2 illustrates a basic example pipeline 200, in other examples processor 110 can include additional or fewer stages, perform the stages in various orders, repeat iterations, and/or perform stages in parallel. For instance, as an instruction proceeds through the stages, a next instruction can follow so as not to leave a stage inactive. However, certain instructions (e.g., a branch such as a conditional jump instruction) can change the next instruction depending on a result of executing the instruction. For example, a conditional jump can be “taken” such that the next instruction jumps to a different place in program memory. Alternatively, the conditional jump can be “not taken” such that the next instruction continues with the next instruction in the program memory.

As further illustrated in FIG. 1, processor 110 can include flow-control circuitry 112. Flow-control circuitry 112 represents any type of circuitry for transferring (e.g., transmitting) data (e.g., data 114), and/or managing data transfer (e.g., regulating a rate of data transfer), from a first node 116 to a second node 118 within system 100 via a link 119 within system 100. Flow-control circuitry 112 can be located anywhere within system 100. In some examples, flow-control circuitry 112 can be located on fist node 116 and/or second node 118.

First node 116 and second node 118 represent any type or form of nodes. In some examples (as depicted in FIG. 1), first node 116 and second node 118 can represent two nodes in one processor, such as a first and second die in an integrated circuit (e.g., a first die 302 and a second die 304 within a multi-die integrated circuit 300 illustrated in FIG. 3).

The term “multi-die integrated circuit” can refer to any type or form of hardware-implemented processing unit, capable of interpreting and/or executing computer-readable-instructions, that includes multiple dies (e.g., first die 302 and second die 304) integrated in a single package. Each die can represent a single (e.g., continuous) semiconductor material (e.g., silicone) that houses one or more of the integrated circuit's processor cores. In some examples, the dies can be vertically stacked. The dies can include a base (e.g., primary) die and one or more additional dies (e.g., including an extensible 3D graphics (X3D) die).

In some examples (not depicted in FIG. 1), first node 116 can correspond to processor 110 and second node 118 can correspond to a different (additional) processor. In one such example, first node 116 can correspond a first socket, corresponding to a first die on processor 110, and second node 118 can correspond to a second socket, corresponding to a second die on an additional processor, both of which are located on a same printed circuit board (e.g., first socket 402 and second socket 404 on printed circuit board 400 in FIG. 4).

First node 116 and second node 118 can be connected (e.g., via link 119) in a variety of ways (e.g., via a variety of protocols, such as a socket-to-socket global memory interface (xGMI) and/or Universal Chiplet Interconnect Express (UCIe)). Link 119 represents any type or form of protocol and/or physical structure used to transfer data from first node 116 to second node 118. In some examples, system 100 can be configured to transfer data from a Transmit-Data-First-in-First-Out (TxFIFO) storage corresponding to first node 116 to a Receive-Data-First-in-First-Out (RxFIFO) storage corresponding to second node 118. In certain examples, the rate (e.g., frequency) at which first node 116 is capable of releasing data (e.g., from a TxFIFO) can differ from the rate at which second node 118 is capable of receiving data (e.g., to an RxFIFO). These rates can also differ from a rate at which data is capable of being transmitted (via link 119) from first node 116 to second node 118.

Flow-control circuitry 112 can regulate the rate of data transfer between first node 116 and second node 118 (e.g., the rate at which data is transmitted from first node 116 and the rate at which data is received at second node 118) in a variety of ways. In some examples, flow-control circuitry 112 can set a transfer rate 128 (e.g., a designated frequency of data transmission) to a rate (e.g., frequency) that corresponds to the lowest of three maximum rates (e.g., bandwidths). These rate can include a first maximum rate 122, at which first node 116 is predicted to be able to release data 114, a second maximum rate 124, at which data 114 is predicted to be able to pass through link 119 from first node 116 to second node 118, and a third maximum rate 126, at which second node 118 is predicted to be able to receive data 114. In some examples, flow-control circuitry 112 can receive and/or calculate transfer rate 128 (e.g., in real-time).

In some examples, flow-control circuitry 112 can be configured to update transfer rate 128 (e.g., based on real-time feedback). In one example, flow-control circuitry 112 can reduce transfer rate 128 (e.g., in response to determining that an amount of data that has accumulated at the RxFIFO corresponding to second node 118 has exceeded a threshold). In some examples, the RxFIFO corresponding to second node 118 can be associated with a programmable threshold. In these examples, in response to determining that an amount of data that has accumulated at the RxFIFO is above the programmable threshold, flow-control circuitry 112 can be configured to update transfer rate 128. In some examples, flow-control circuitry 112 can update transfer rate 128 by sending a request to first node 116 to reduce transfer rate 128 (e.g., using a ‘Drop one clock TxReady’ field in a ‘PCS information exchange packet’).

FIG. 5 is a flow diagram of an exemplary computer-implemented method 500 for transmitting data (and/or managing data transmission) from a first node to a second node. The steps shown in FIG. 5 can be performed by any suitable circuit, computer-executable code and/or computing system, including the system(s) illustrated in FIGS. 1, 3, and/or 4. In one example, each step represents an algorithm whose structure includes and/or is represented by multiple sub-steps, examples of which will be provided in greater detail below.

As illustrated in FIG. 5, at step 502 one or more of the systems described herein can transmit data through a link, from a first node to a second node of a device, at a designated frequency (e.g., a transfer rate) corresponding to the lowest of three maximum frequencies (e.g., a first maximum frequency at which the first node is predicted to be able to release data, a second maximum frequency at which data is predicted to be able to pass through the link from the first node to the second node, and a third maximum frequency at which the second node is predicted to be able to receive data).

The three maximum frequencies can be determined in a variety of ways. In some examples, the first maximum frequency can be determined based on an observed frequency of data released from the first node and the third maximum frequency can be determined based on an observed frequency of data received at the second node. In one example, the second maximum frequency (e.g., a link speed) can be determined based on the data byte number in a data packet transmitted over the link. For example, the second maximum frequency can be determined by dividing the data byte number in a data packet by the result of adding the data byte number, in the data packet, to a measure of overhead in the data packet (e.g., the data byte number/(the data byte number+the measure of overhead)).

In some examples, one or more of the systems can set and/or calculate the designated frequency by (1) determining the lowest of the three maximum frequencies and (2) in response to determining the lowest of the three maximum frequencies, setting the designated frequency at the lowest of the three maximum frequencies. In some examples, the three maximum frequencies can be determined in real-time (e.g., based on real-time monitoring). Additionally or alternatively, the three maximum frequencies can be retrieved from a specification corresponding to the link and the nodes.

In some examples, the systems can perform the steps described here in the context described in FIGS. 1-4 (e.g., using any of the features described in connection with FIGS. 1-4). Similarly, any of the features described in connection with FIG. 5 can be applied to the features described in connection with FIGS. 1-4.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a first node;
a second node;
a link; and
flow-control circuitry configured to transmit data through the link, from the first node to the second node, at a designated frequency corresponding to the lowest of three maximum frequencies, the three maximum frequencies comprising:
a first maximum frequency at which the first node is predicted to be able to release data;
a second maximum frequency at which data is predicted to be able to pass through the link from the first node to the second node; and
a third maximum frequency at which the second node is predicted to be able to receive data.

2. The device of claim 1, wherein the first node is a first die and the second node is a second die within an integrated circuit.

3. The device of claim 1, wherein the first node is a first socket, corresponding to a first die on a printed circuit board, and the second node is a second socket, corresponding to a second die on the printed circuit board.

4. The device of claim 1, wherein the flow-control circuitry is located on the first node.

5. The device of claim 1, wherein:
at least one of the first, second, or third maximum frequencies are dynamic frequencies; and
the flow-control circuitry is configured to determine the designated frequency in real-time.

6. The device of claim 1, wherein the flow-control circuitry transmits data from the first node to the second node by transmitting data from Transmit-Data-First-in-First-Out (TxFIFO) storage of the first node to Receive-Data-First-in-First-Out (RxFIFO) storage of the second node.

7. The device of claim 6, wherein the flow-control circuitry is further configured to reduce the frequency at which subsequent data is transmitted, through the link from the first node to the second node, in response to determining that an amount of data that has accumulated, at the RxFIFO storage of the second node, exceeds a threshold.

8. A system comprising:
a physical memory;
a first node configured to transfer data to a second node via a link; and
flow-control circuitry configured to regulate a rate of data transfer from the first node to the second node by setting the transfer rate to a rate that corresponds to the lowest of three rates, the three rates comprising a first rate at which the first node is predicted to be able to release data, a second rate at which data is predicted to be able to pass through the link from the first node to the second node, and a third rate at which the second node is predicted to be able to receive data.

9. The system of claim 8, wherein the first node is a first die and the second node is a second die within an integrated circuit.

10. The system of claim 8, wherein the first node is a first socket, corresponding to a first die on a printed circuit board, and the second node is a second socket, corresponding to a second die on the printed circuit board.

11. The system of claim 8, wherein the flow-control circuitry is located on the first node.

12. The system of claim 8, wherein the flow-control circuitry is configured to calculate the transfer rate in real-time.

13. The system of claim 8, wherein the flow-control circuitry transfers data from the first node to the second node by transferring data from Transmit Data First in First Out (TxFIFO) storage of the first node to Receive Data First in First Out (RxFIFO) storage of the second node.

14. The system of claim 13, wherein the flow-control circuitry is further configured to reduce the rate at which subsequent data is transmitted, through the link from the first node to the second node, in response to determining that an amount of data that has accumulated, at the RxFIFO storage of the second node, exceeds a threshold.

15. A computer-implemented method comprising:
transmitting data through a link, from a first node to a second node of a device, at a designated frequency corresponding to the lowest of three maximum frequencies, the three maximum frequencies comprising a first maximum frequency at which the first node is predicted to be able to release data, a second maximum frequency at which data is predicted to be able to pass through the link from the first node to the second node, and a third maximum frequency at which the second node is predicted to be able to receive data.

16. The computer-implemented method of claim 15, further comprising:
determining the lowest of the three maximum frequencies; and
in response to determining the lowest of the three maximum frequencies, setting the designated frequency at the lowest of the three maximum frequencies.

17. The computer-implemented method of claim 15, further comprising calculating the designated frequency in real-time.

18. The computer-implemented method of claim 15, wherein:
the first node comprises at least one of a first die or a first socket; and
the second node comprises at least one of a second die or a second socket.

19. The computer-implemented method of claim 15, wherein transmitting data from the first node to the second node comprises transmitting data from Transmit Data First in First Out (TxFIFO) storage of the first node to Receive Data First in First Out (RxFIFO) storage of the second node.

20. The computer-implemented method of claim 19, further comprising reducing the frequency at which subsequent data is transmitted, through the link from the first node to the second node, in response to determining that above a threshold amount of data has accumulated at the RxFIFO storage of the second node.
